(19) United States
(12) Patent Application Publication
(10) Pub. No.: US 2024/0304176 A1
(43) Pub. Date: Sep. 12, 2024

(54) SYSTEMS AND METHODS FOR SUMMARY GENERATION USING VOICE INTELLIGENCE

(71) Applicant: Wells Fargo Bank, N.A., San Francisco, CA (US)

(72) Inventors: Himanshu Baral, Fremont, CA (US); Rameshchandra Bhaskar Ketharaju, Hyderabad (IN)

(21) Appl. No.: 18/180,440

(22) Filed: Mar. 8, 2023

(51) Int. Cl. G10L 13/08; G06F 16/34; G10L 13/027; G10L 15/16

(52) U.S. Cl. CPC G10L 13/08; G06F 16/345; G10L 13/027; G10L 15/16

(57) ABSTRACT

Systems, apparatuses, methods, and computer program products are disclosed for generating summaries using a voice intelligence system. An example method includes: obtaining a piece of data; identifying an actual feature in the piece of data using a generative adversarial network (GAN); generating, based on the actual feature, a summary of the piece of data; causing display of the summary.

### BACKGROUND

Computing devices may provide various services. Computing devices may also be trained to automatically provide such services without human intervention.

### BRIEF SUMMARY

Data visualization and summarization are often important but overlooked aspect for presenting data. Typically, data summaries are driven primarily by an author or presenter of the data. As such, data summaries, such as summaries for graphs and charts, may be highly variable and/or inconsistent. This may lead to different user experiences and in some instances, even the presentation of conflicting information. As such, it may be advantageous for a system which can standardize the summary of data and/or present the data summary to an audience.

In contrast to current methods for summary generation, one or more embodiments herein disclose a voice intelligence system that may be used to automatically generate (e.g., using a generative adversarial network (GAN) model) a data summary for data and may optionally present the data summary using a generated audio snippet. The voice intelligence system may be configured to process data, such as images (e.g., charts, graphs, pictures etc.) and generate a data summary for the data. In some instances, the voice intelligence system may generate audio snippets for the data summary for presentation to an audience. Alternatively, the voice intelligence system may generate a script or text summary of the image for a user. Because summaries generated using the GAN model are based on a standardized model, instances of conflicting information generated using the same source (e.g., the same image or graph) can be effectively reduced. As a result, one or more embodiments disclosed herein provide a direct improvement in the technical field of information and communication technology.

Additionally, the voice intelligence system of one or more embodiments can be used in an “eyes in the sky” configuration. In the “eyes in the sky” configuration, the voice intelligence system may be configured to monitor one or more key performance indicators (KPIs) and alert one or more users when any of the KPIs exceed or fall below a predetermined threshold. For example, the voice intelligence system may be used in a hospital setting where a patient's KPI (e.g., blood-pressure, temperature, white-blood-cells count, or the like) are monitored. When any of the patient's KPIs reach a preset limit (e.g., reach a critical level), the voice intelligence system may be configured to alert (e.g., using a generated summary of the patient's present critical condition) one or more hospital members (e.g., doctors, nurses, or the like) to entice these members to act and save the patient's life. Because the summary is generated based on a standardized format set by the hospital, situations where an incorrect summary reported by an inexperienced hospital staff member (e.g., situations caused by avoidable human error) could be reduced (and even completely avoided). Therefore, such “eyes in the sky” configuration further enables one or more embodiments disclosed to provide a direct improvement in the technical field of emergency response technology.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a device that may perform various operations in accordance with some example embodiments described herein.

FIG. 3 illustrates an example flowchart for generating summaries using a voice intelligence system, in accordance with some example embodiments described herein.

FIG. 4 illustrates another example flowchart for generating summaries using a voice intelligence system, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

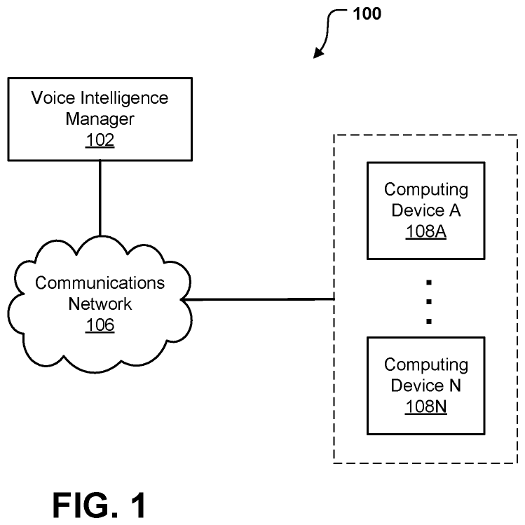

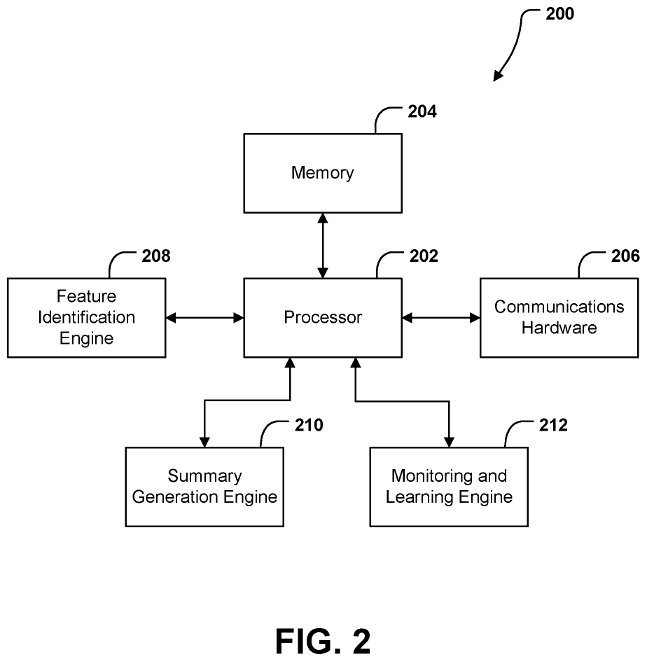

Example embodiments described herein may be implemented using any of a variety of computing devices or servers. To this end, FIG. 1 illustrates an example system 100 within which various embodiments may operate. As illustrated in FIG. 1, the system may include a voice intelligence manager 102 that may receive and/or transmit information via communications network 106 (e.g., the Internet) with any number of other devices, such as computing devices 108A-108N. In some embodiments, individuals may directly interact with the voice intelligence manager 102 (e.g., via communications hardware 206 of voice intelligence manager 102, which is discussed in more detail below in reference to FIG. 2), in which case a separate computing device connected to the voice intelligence manager 102 (e.g., in an instance where the voice intelligence manager 102 is a server disposed at a location that is not physically accessible to the individual) may not be utilized. Whether by way of direct interaction or via a separate computing device, an individual may communicate with, operate, control, modify, or otherwise interact with the voice intelligence manager 102 to perform the various functions and achieve the various benefits described herein.

In some embodiments, voice intelligence manager 102 may be implemented as one or more computing devices or servers, which may be composed of a series of components. Particular components of the threat manager are described in greater detail below with reference to apparatus 200 in FIG. 2.

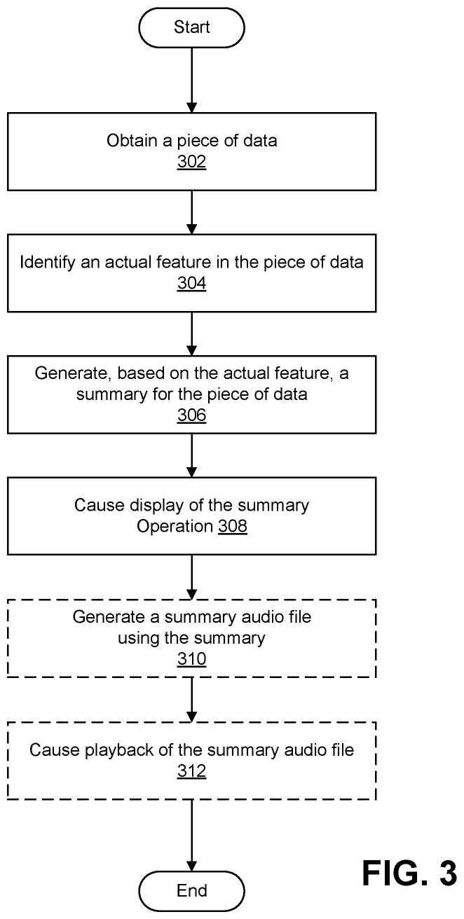

In some embodiments, the computing devices 108A-108N may be embodied by any computing devices known in the art such as desktop or laptop computers, mobile phones (e.g., smart phones), tablets, servers, server devices, or the like. Each of the computing devices 108A-108N need not themselves be independent devices, but may be peripheral devices communicatively coupled to other computing devices. For example, each of the computing devices 108A-108N may be a computing device belonging to an individual (or group) within an organization. As another example, each of the computing devices 108A-108N may be a server provisioned with software enabling the server to provide one or more computing services (e.g., the operations of one or more embodiments discussed in more detail below in reference to the flowchart of FIG. 3).

### Example Implementing Apparatuses

The voice intelligence manager 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIG. 3. As illustrated in FIG. 2, the apparatus 200 may include processor 202, memory 204, communications hardware 206, feature identification engine 208, summary generation engine 210, and monitoring and learning engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display and one or more sensors (e.g., temperature sensors, thermal sensors, audio sensors, vibration sensors, or the like), and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a feature identification engine 208 that is configured to identify one or more features in a piece of data (e.g., text, an image, a graph, a table, a video file, an audio recording, or any combination thereof) using a trained generative adversarial network (GAN) model. The feature identification engine 208 may utilize processor 202, memory 204, or any other hardware component included in the apparatus 200 to perform these operations, as described in connection with FIG. 3 below. The feature identification engine 208 may further utilize communications hardware 206 to gather data from a variety of sources (e.g., any of the computing devices 108A-108N, as shown in FIG. 1), and/or exchange data with an individual (e.g., a user, an administrator, a customer, or the like), and in some embodiments may utilize processor 202 and/or memory 204 to identify one or more features in a piece of data using the trained GAN (as described in more detail below in reference to FIG. 3).

In addition, the apparatus 200 further comprises a summary generation engine 210 that is configured to generate one or more summaries of the piece of data. The summary generation engine 210 may utilize processor 202, memory 204, or any other hardware component included in the apparatus 200 to perform these operations, as described in connection with FIG. 3 below. The summary generation engine 210 may further utilize communications hardware 206 to gather data from a variety of sources (e.g., any of the computing devices 108A-108N, as shown in FIG. 1), and/or exchange data with a user, and in some embodiments may utilize processor 202 and/or memory 204 to generate the summaries of the piece of data (as described in more detail below in reference to FIG. 3).

In addition, the apparatus 200 further comprises a monitoring and learning engine 212 that is configured to monitor and learn a condition of one or more monitoring targets (e.g., a human patient, a trend in data, or the like). The monitoring and learning engine 212 may utilize processor 202, memory 204, or any other hardware component included in the apparatus 200 to perform these operations, as described in connection with FIG. 3 below. The monitoring and learning engine 212 may further utilize communications hardware 206 to gather data from a variety of sources (e.g., any of the computing devices 108A-108N, as shown in FIG. 1), and/or exchange data with a user, and in some embodiments may utilize processor 202 and/or memory 204 to monitor and learn a condition of one or more monitoring targets (as described in more detail below in reference to FIG. 3).

Although components 202-212 are described in part using functional language, it will be understood that the particular implementations necessarily include the use of particular hardware. It should also be understood that certain of these components 202-212 may include similar or common hardware. For example, the feature identification engine 208, summary generation engine 210, and monitoring and learning engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the feature identification engine 208, summary generation engine 210, and monitoring and learning engine 212 may leverage processor 202, memory 204, or communications hardware 206 as described above, it will be understood that any of the feature identification engine 208, summary generation engine 210, and monitoring and learning engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the feature identification engine 208, summary generation engine 210, and monitoring and learning engine 212 comprise particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of flowcharts.

### Example Operations

Turning to FIG. 3, an example flowchart is illustrated that contain example operations implemented by example embodiments described herein. The operations illustrated in FIG. 3 may, for example, be performed by the voice intelligence manager 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, feature identification engine 208, summary generation engine 210, monitoring and learning engine 212, and/or any combination thereof. It will be understood that user interaction with the voice intelligence manager 102 may occur directly via communications hardware 206, or may instead be facilitated by a separate computing device (not shown in the figures) that may have similar or equivalent physical componentry facilitating such user interaction.

Turning to FIG. 3, example operations are shown for generating one or more summaries using a voice intelligence system.

As shown by operation 302, the apparatus 200 includes means, such as processor 202, memory 204, communications hardware 206, feature identification engine 208, or the like, for obtaining a piece of data.

In some embodiments, the piece of data may be any piece of information or facts that can be stored and processed by a computer or other electronic device. The piece of data may take many forms, including numbers, text, images, charts, graphs, video, audio, or the like. The piece of data may also be stored in any format (e.g., DOCX, XML, PDF, AVI, MP3, etc.) and in any size. Examples of the piece of data include and are not limited to: quarterly reports; purchase histories in a company's database; stock prices and financial indicators on a trading platform; weather maps from a weather station; the results of a scientific experiment; or the like.

In some embodiments, the piece of data may be obtained from any source such as: an internal source including memory 204 of apparatus 200; an internal source such as received through communications hardware (e.g., uploaded by a user of apparatus 200 through a universal serial bus (USB)); an external source such as any of computing devices 108A-108N shown in FIG. 1; or the like.

As shown by operation 304, the apparatus 200 includes means, such as processor 202, memory 204, communications hardware 206, feature identification engine 208, or the like, for identifying an actual feature in the piece of data. In some embodiments, an actual feature in the piece of data is a feature (e.g., a trend, a data point, a term, a colour, a pattern, or the like and any combination thereof) that actually appears in the piece of data and may make up a core component of the piece of data. For example, assume that the piece of data is an image that includes a dog eating a dandelion. “Dog” and “dandelion” would be examples of actual features in the piece of data.

In some embodiments, the feature identification engine 208 is configured with a trained GAN model to process the piece of data in order to identify one or more actual features in the piece of data. In some embodiments, the GAN model may be any type of known GAN model that includes at least one generator and at least one discriminator. In some embodiments, the generator(s) of the GAN model may be trained (e.g., using any known machine learning and artificial intelligence training techniques including natural language processing (NLP) techniques, pattern and feature recognition techniques, optical character recognition (OCR) techniques, or the like) to parse the piece of data in order to identify and classify one or more potential features in the piece of data. For example, the generator may be trained using supervised learning where a set of known (and labeled) data compiled from various sources (e.g., public sources such as the Internet, internal sources including an entity or corporation's propriety information and data, or the like) is ingested into the generator for the generator to know what a feature is and what features to look for in different types of data. Alternatively, the generator may also be trained using one or more known unsupervised learning techniques to be able to identify and classify potential features in data.

In some embodiments, classifying potential features by the generator may include providing the potential feature with a description. For example, using the same example above where the piece of data is an image that includes a dog eating a dandelion, the potential features would be “dog” and “dandelion,” and the descriptions for each potential features could be “dog eating an object” and “a dandelion in a dog's mouth.” As another example, assume that the piece of data is a graph. The generator may be configured (e.g., trained) to identify axes features, data point features, trend features, or the like as potential features within the graph.

In some embodiments, the discriminator of the GAN model of the feature identification engine 208 may be trained (e.g., using any known machine learning and artificial intelligence training techniques including natural language processing (NLP) techniques, pattern and feature recognition techniques, optical character recognition (OCR) techniques, or the like) to analyze and confirm the accuracy of the generator's results. Said another way, the discriminator may be trained to analyze the piece of data, the potential feature(s) identified by the generator, and the descriptions of the potential feature(s) generated by the generator to confirm an accuracy of the potential feature(s) and their respective descriptions. For example, using the same example above where the piece of data is an image that includes a dog eating a dandelion, the discriminator would analyze the image and confirm that the image includes “a dog eating an object” and “a dandelion in a dog's mouth.”

In some embodiments, based on the analysis of the piece of data, the discriminator may approve or reject one or more of the potential features (and their respective descriptions) identified by the generator. Any potential features (and their respective descriptions) approved by the discriminator will be finalized (e.g., tagged) as an actual feature of the piece of data. Any potential features (and their respective descriptions) rejected by the discriminator may be flagged and set aside for review by a user (e.g., an administrator and/or developer of the GAN model). The discriminator's results (e.g., the approval and rejections by the discriminator) may be fed back into the generator to further train and improve and accuracy of the generator (e.g., to obtain a further trained GAN model (referred to herein as an “updated GAN model”).

In some embodiments, the training of the discriminator may also include a human-in-the-loop (HITL) element. More specifically, the discriminator's results (e.g., the approval and rejections by the discriminator) may be analyzed and evaluated by an administrator and/or developer of the GAN model. The results of the human evaluation would then be fed back into the discriminator to further train and improve and accuracy of the discriminator (e.g., to obtain an updated GAN model).

In some embodiments, using the trained GAN model of the feature identification engine 208 to identify actual features within pieces of data advantageously creates a single, standardized process for identifying such actual features. This single, standardized process would advantageously be able to reduce the amount of human bias and human error introduced when the same piece of data is analyzed and evaluated by two different individuals for identifying the actual features in that same piece of data. As a result, conflicting information can be effectively eliminated, which provides a direct improvement in the field of information and communication technology.

As shown by operation 306, the apparatus 200 includes means, such as processor 202, memory 204, communications hardware 206, summary generation engine 210, or the like, for generating a summary for the piece of data. In some embodiments, the summary may be generated using the actual feature(s) of the piece of data (e.g., the actual feature(s) identified in operation 304).

In particular, in some embodiments, once the GAN model of the feature identification engine 208 identifies and classifies the actual feature(s) of the piece of data, the identified and classified feature(s) are provided (e.g., by the feature identification engine 208) to the summary generation engine 210. Alternatively, in some embodiments, the actual feature(s) may first be stored in a database (e.g., a database configured by in memory 204 of the apparatus 200), and the summary generation engine 210 will retrieve the actual feature(s) from the database rather than directly receive the actual feature(s) from the feature identification engine 208.

In some embodiments, once the summary generation engine 210 receives the actual feature(s), the summary generation engine 210 may employ one or more NLP techniques to generate a summary of the piece of the data using the actual feature(s). In some embodiments, the summary generation engine 210 may be configured as a back-end engine that uses one or more neural networks (e.g., a long short-term memory (LSTM) model, or the like) to generate the summary. The summary may be generated as a text summary pertaining to the piece of data obtained in operation 302. Alternatively, the summary generation engine 210 may be configured as a back-end engine that uses one or more deep learning techniques (e.g., Generative Pre-trained Transformer 3 (GPT-3), or the like) to generate the summary. For example, using the same example above of the image containing a dog eating a dandelion, the summary generation engine 210 may generate an example summary of “This is an image of a dog eating a dandelion.”

As shown by operation 308, the apparatus 200 includes means, such as processor 202, memory 204, communications hardware 206, summary generation engine 210, or the like, for causing display of the summary to a user (e.g., a user who submitted the piece of data in operation 302). In particular, in some embodiments, the apparatus 200 may transmit (e.g., using communications hardware 206) the summary (e.g., the text summary) generated in operation 306 to an external device (e.g., any one of computing devices 108A-108N of FIG. 1) to be displayed on the external device (e.g., via a display or screen connected to the external device). Alternatively or additionally, the apparatus 200 may cause the summary to be displayed (e.g., using communications hardware 206) on a display connected to the apparatus 200.

In some embodiments, the summary generation engine 210 may generate the summary based on an audience of the summary (e.g., one or more individuals to which the summary will be presented). In particular, at any point during operations 302-306, the summary generation engine 210 may receive information that specifies (e.g., identifies) an audience of the summary. Additionally or alternatively, the summary generation engine 210 may identify the audience by parsing (e.g., using NLP, OCR, or the like) by parsing the piece of data.

In some embodiments, once the audience is identified, the summary generation engine 210 may determine one or more characteristics of the audience. The characteristics of the audience may include: an age; a race; a title; a level of education; a primary language of the audience; a privilege/permission level; or the like. In some embodiments, the summary generation engine 210 may determine one or more characteristics of the audience by: cross-checking a database (e.g., a database in memory 204) storing information on the audience; directly receiving (e.g., via communications hardware 206 of apparatus 200) the characteristic(s) from a user that submitted the piece of data; making inferences (e.g., using one or more known machine learning techniques) based on a title or position of the audience where the title is provided as part of the information specifying the audience; or the like. Other known techniques not specified above for determining one or more characteristics of the audience may also be used without departing from the scope of one or more embodiments disclosed herein.

In some embodiments, once the characteristic(s) of the audience are identified, the summary generation engine 210 may customize the summary (e.g., the summary being generated in operation 306) based on the identified characteristic(s) of the audience. For example, customizing the summary based on the characteristic(s) of the audience may include at least one of: reducing or increasing a comprehensive complexity of diction making up the summary; shortening or lengthening a length of the summary; decreasing or increasing a playback speed of a summary audio file (the summary audio file is described in more detail below in reference to operation 310); changing a language of the summary or a playback language of the summary audio file; redacting and/or omitting one or more portions of the summary based on the permission/privilege level of the audience; or the like.

In some embodiments, in an instance where the summary generation engine 210 redacts or omits one or more portion of the summary based on the permission/privilege level of the audience, the summary generation engine 210 may also generate a notification to the audience specifying that one or more portions (e.g., features) of the original piece of data has been omitted or redacted and that the audience should contact the original owner of the piece of data to obtain the omitted and/or redacted information. In some embodiments, the audience of the summary may be the user that submitted the piece of data to the apparatus 200 in operation 302.

In some embodiments, in instances where the summary generation engine 210 identifies multiple audiences, the summary generation engine 210 may generate multiple ones of the summary each customized based on the audience for which the summary is to be presented. Alternatively, the summary generation engine 210 may send a notification (e.g., via communications hardware 206) to the user that submitted the piece of data in operation 302 to seek further input from the user with regard to how the summary should be customized such that the summary can be suitable for all of the identified audiences.

As shown by operation 310, the apparatus 200 includes means, such as processor 202, memory 204, communications hardware 206, summary generation engine 210, or the like, for generating an audio version of the summary. In some embodiments, the summary generation engine 210 may generate the summary as (in addition to or alternatively as) an audio snippet (e.g., an audio summary) (hereinafter referred to as a “summary audio file”). The summary audio file may be generated using the initially generated text summary (e.g., using one or more known text-to-speech conversion techniques). In some embodiments, the summary audio file may be generated at the same time as the text summary (e.g., the text summary is converted into the summary audio file immediately after the text summary is generated) or at anytime after the text summary is generated. Like the text summary, the summary audio file may also be generated based on the audience to which the summary audio file is to be played back.

As shown by operation 312, the apparatus 200 includes means, such as processor 202, memory 204, communications hardware 206, summary generation engine 210, or the like, for causing playback of the summary audio file. In particular, in some embodiments, the apparatus 200 may transmit (e.g., using communications hardware 206) the summary audio file to an external device (e.g., any one of computing devices 108A-108N of FIG. 1) to be played back (e.g., via speakers) by the external device. Alternatively or additionally, the apparatus 200 may cause (e.g., using communications hardware 206) the summary audio file to be played back using external speakers connected to the apparatus 200.

In some embodiments, at any time after the summary (and/or the audio summary file) is generated and provided to the user and/or audience, the apparatus may obtain (from the user and/or audience) a feedback for the summary. The feedback may specify one or more observations, comments, and/or critiques about what is good about the summary and/or what the summary is lacking. For example, using the same example above where the piece of data is an image that includes a dog eating a dandelion, the feedback may include comments such as “the dog is a golden retriever.” The feature identification engine 208 may use the obtained feedback to further train the GAN model (e.g., to obtain the updated GAN) by further training the GAN using the feedback such that the GAN model can (ideally) better identify golden retrievers in subsequently received pieces of data. Said another way, the GAN model is further trained to identify actual features of obtained pieces of data using the received feedback.

In some embodiments, the feedback may also include a request for additional data. For example, using the same example above where the piece of data is an image that includes a dog eating a dandelion, the feedback may include a request such as “where is the dog standing?” or “is the dog eating the stem or flower portion of the dandelion?” The feature identification engine 208 may use the additional request to further train the GAN model (e.g., to obtain the updated GAN) to identify (e.g., without or without help from an administrator and/or developer of the GAN model) the additional data, and subsequently identify (e.g., using the updated GAN) additional actual features of the piece of data associated with the additional data specified in the request. The summary generation engine 210 would subsequently use the actual features of the piece of data associated with the additional data specified in the request to generate a new summary. This new summary may be generated based on only the newly identified actual features of the piece of data associated with the additional data specified in the request and/or be generated using all of the actual features identified up to this point (e.g., using the initial actual features identified in operation 304 and the newly identified actual features of the piece of data associated with the additional data specified in the request).

In some embodiments, apparatus 200 may be configured to use an edge compute scheme. In particular, the apparatus 200 may use external computing devices (e.g., any of the computing devices 108A-108N) as edge nodes on the communications network 106 of FIG. 1 to execute one or more processes (e.g., back-end processes of generating the summary originally executed by the summary generation engine 210) on the edge nodes. This advantageously reduces the delays in generation of the summary if the apparatus 200 does not have enough computing resources to generate the summary (or is being slowed down by the feature identification engine 208) while the feature identification engine 208 is parsing multiple ones of the piece of data using the GAN model, which could be a resource intensive process.

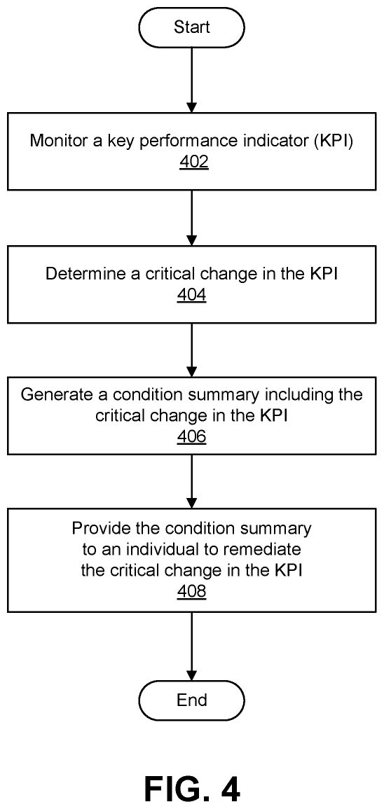

Turning now to FIG. 4 an example flowchart is illustrated that contain example operations implemented by example embodiments described herein. The operations illustrated in FIG. 4 may, for example, be performed by the voice intelligence manager 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, feature identification engine 208, summary generation engine 210, monitoring and learning engine 212, and/or any combination thereof. It will be understood that user interaction with the voice intelligence manager 102 may occur directly via communications hardware 206, or may instead be facilitated by a separate computing device (not shown in the figures) that may have similar or equivalent physical componentry facilitating such user interaction.

Turning to FIG. 4, example operations are shown for generating one or more summaries using a voice intelligence system configured as an “eyes in the sky” system.

As shown by operation 402, the apparatus 200 includes means, such as processor 202, memory 204, communications hardware 206, feature identification engine 208, monitoring and learning engine 212, or the like, for monitoring one or more key performance indicators (KPIs) in a piece of data (e.g., the piece of data obtained in operation 302 of FIG. 3) (also referred to herein as a “monitoring target”).

In some embodiments, the monitoring and learning engine 212 may identify the KPI(s) based on information provided by a user (e.g., the user directly instructs the monitoring and learning engine 212 to monitor specific KPI(s)). Alternatively, the feature identification engine 208 may be configured to identify (e.g., using the trained GAN model) one or more of the identified actual features (e.g., the actual feature(s) identified in operation 304 of FIG. 3) as the KPI(s), and provide the identified KPI(s) to the monitoring and learning engine 212. In some embodiments, the monitoring and learning engine 212 may directly monitor a source of the piece of data.

As an example, assume that the piece of data is a live chart of a hospital patient's vitals. In this example, the KPI(s) may include any combination of the patient's blood-pressure, temperature, white-blood-cells count, heart rate, oxygen levels, or the like. The monitoring and learning engine 212 may directly monitor one or more medical devices that are monitoring and reporting these KPI(s) of the patient.

As shown by operation 404, the apparatus 200 includes means, such as processor 202, memory 204, communications hardware 206, monitoring and learning engine 212, or the like, for determining whether there is a critical change in the KPI(s). In some embodiments, a critical change in a KPI occurs when a value of the KPI exceeds or falls below one or more predetermined thresholds (e.g., a maximum threshold, a minimum threshold, or the like).

Continuing with the above example, the monitoring and learning engine 212 may determine that a critical change in the KPI has occurred if the patient's oxygen level falls below a minimum threshold of, for example, 95% (set as a standard by the hospital).

As shown by operation 406, the apparatus 200 includes means, such as processor 202, memory 204, communications hardware 206, feature identification engine 208, the summary generation engine 210, monitoring and learning engine 212, or the like, for generating a summary of the condition of the monitoring target (referred to below as a “condition summary”) including the critical change in the KPI.

In some embodiments, the condition summary may be generated using the same process discussed in FIG. 3. For example, continuing with the above example about the hospital patient, in the instance that the monitoring and learning engine 212 detects the critical change in the KPI, the monitoring and learning engine 212 may cause the feature identification engine 208 and summary generation engine 210 to generate a current summary of the patient's condition (e.g., a condition summary for the patient) based on the data (e.g., the live charts of the patient's vitals) being produced by the medical devices being monitored by the monitoring and learning engine 212.

In some embodiments, based on the KPI(s) being monitored, the feature identification engine 208 and summary generation engine 210 may be configured to include addition KPI(s) (e.g., KPIs that are being monitored but not experiencing a critical change) within the generated condition summary. Inclusion of such additional KPI(s) may be based on a rule-database stored in memory 204 of apparatus 200. Continuing with the above example about the hospital patient, instead of just including the oxygen level that has experienced the critical change, other vitals that could help a medical professional better assess and remediate the critical change in the oxygen level would also be included in the condition summary.

As shown by operation 408, the apparatus 200 includes means, such as processor 202, memory 204, communications hardware 206, monitoring and learning engine 212, or the like, for providing the condition to an individual to remediate the critical change in the KPI.

In some embodiments, the condition summary may be generated as either or both of the text summary and audio summary file. The apparatus 200 may identify one or more audiences (e.g., using the same processes discussed above in reference to FIG. 3) to which the condition should be transmitted in order for remediation of the critical change in the KPI. Continuing with the above example about the hospital patient, the condition summary may be directly paged to a medical professional's (e.g., a doctor and/or nurse's) pager. Additionally or alternatively, the condition summary may be transmitted to a central computer of the hospital where the central computer would be instructed by the apparatus to broadcast the critical change to certain portions of the hospital where such medical professionals could be located.

FIGS. 3 and 4 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable improved communication of data and information. For example, by providing a standardized process for analyzing and evaluating pieces of data (e.g., using a GAN model in one or more embodiments discussed above), human bias and human error may be reduced and/or eliminated from the summary (e.g., descriptions) produced for the pieces of data. This way, conflicting information generated by two different individuals analyzing the same piece of data could also be reduced and/or eliminated, which results in a more efficient and effective (e.g., improved) way to communicate information across digital platforms within a corporation and/or entity where multiple individuals with different levels of education and/or understanding of a subject matter may be exposed to (and be required to analyze) the same piece of data.

As these examples all illustrate, example embodiments contemplated herein provide technical solutions that solve real-world problems faced during electronic communication of data in information within a corporation or entity. And while the current trend in technology allows for individuals to communicate information between one another, the inventors have found the importance of minimizing the discrepancy and conflicting information being circulated among these individuals. As a result, one or more embodiments disclosed herein provide a direct improvement in the technical field of electronic information communication.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
obtaining, via communications hardware of a voice intelligence manager, a piece of data;
identifying, by a feature identification engine of the voice intelligence manager, an actual feature in the piece of data using a generative adversarial network (GAN);
generating, by a summary generation engine of the voice intelligence manager and based on the actual feature, a first summary of the piece of data; and
causing, by the summary generation engine, display of the first summary.

2. The method of claim 1, further comprising:
generating, by the summary generation engine, a summary audio file using the first summary; and
causing, by the summary generation engine, playback of the summary audio file.

3. The method of claim 2, wherein the piece of data comprises at least one of an image, an audio recording, or a video.

4. The method of claim 2, further comprising:
identifying, by the summary generation engine, an audience for the summary audio file;
determining, by the summary generation engine, a characteristic of the audience; and
customizing, by the summary generation engine, the first summary of the piece of data and the summary audio file based on the characteristic of the audience.

5. The method of claim 4, wherein customizing the first summary of the piece of data and the summary audio file based on the characteristic of the audience further comprises at least one of, based on the characteristic of the audience:
reducing or increasing, by the summary generation engine, a comprehensive complexity of diction making up the first summary;
shortening or lengthening, by the summary generation engine, a length of the first summary;
decreasing or increasing, by the summary generation engine, a playback speed of the summary audio file;
changing, by the summary generation engine, a language of the first summary or a playback language of the summary audio file; or
redacting or omitting, by the summary generation engine, one or more portions of the first summary or the summary audio file.

6. The method of claim 5, wherein the characteristic of the audience comprises at least one of an age, a race, a title, a level of education, a primary language, or a privilege or permission level of the audience.

7. The method of claim 1, wherein:
the GAN comprises a generator and a discriminator, and
identifying the actual feature of the piece of data using the GAN further comprises:
by the generator:
parsing the piece of data to identify a potential feature, and
classifying the potential feature with a description; and
by the discriminator:
analyzing the piece of data, the potential feature, and the description of the potential feature, and
approving or rejecting the potential feature as the actual feature of the piece of data based on the analyzing.

8. The method of claim 7, further comprising:
receiving, by the communications hardware, a feedback for the first summary;
training, by the feature identification engine, the GAN using the feedback to obtain an updated GAN; and
identifying, by the feature identification engine, actual features of subsequently received pieces of data using the updated GAN.

9. The method of claim 8 wherein:
the feedback comprises a request for additional data;
identifying, by the feature identification engine, a second actual feature of the piece of the data, wherein the second actual feature is associated with the additional data specified in the request;
generating, by the summary generation engine and based on the second actual feature, a second summary of the piece of data, wherein the second summary is different from the first summary; and
causing, by the summary generation engine, display of the second summary.

10. The method of claim 9, wherein the second summary is also generated based on the first actual feature of the piece of data.

11. An apparatus comprising:
communication hardware configured to obtain a piece of data;
a feature identification engine configured to identify an actual feature in the piece of data using a generative adversarial network (GAN);
a summary generation engine configured to:
generate, based on the actual feature, a first summary of the piece of data; and
cause display of the first summary.

12. The apparatus of claim 11, wherein the summary generation engine is further configured to:
generate a summary audio file using the first summary; and
cause playback of the summary audio file.

13. The apparatus of claim 12, wherein the piece of data comprises at least one of an image, an audio recording, or a video.

14. The apparatus of claim 12, wherein the summary generation engine is further configured to:
identify an audience for the first summary audio file;
determine a characteristic of the audience; and
customize the first summary of the piece of data and the summary audio file based on the characteristic of the audience.

15. The apparatus of claim 14, wherein customizing the first summary of the piece of data and the summary audio file based on the characteristic of the audience further comprises at least one of, based on the characteristic of the audience:
reducing or increasing a comprehensive complexity of diction making up the first summary;
shortening or lengthening a length of the first summary;
decreasing or increasing a playback speed of the summary audio file;
changing a language of the first summary or a playback language of the summary audio file; or
redacting or omitting one or more portions of the first summary or the summary audio file.

16. A computer program product comprising at least one non-transitory computer-readable storage medium storing software instructions that, when executed, cause an apparatus to:
obtain a piece of data;
identify an actual feature in the piece of data using a generative adversarial network (GAN);
generate, based on the actual feature, a first summary of the piece of data; and
cause display of the first summary.

17. The computer program product of claim 16, wherein the apparatus is further caused to:
generate a summary audio file using the first summary; and
cause playback of the summary audio file.

18. The computer program product of claim 17, wherein the piece of data comprises at least one of an image, an audio recording, or a video.

19. The computer program product of claim 17, wherein the apparatus is further caused to:
identify an audience for the first summary audio file;
determine a characteristic of the audience; and
customize the first summary of the piece of data and the summary audio file based on the characteristic of the audience.

20. The computer program product of claim 19, wherein customizing the first summary of the piece of data and the summary audio file based on the characteristic of the audience further comprises at least one of, based on the characteristic of the audience:
reducing or increasing a comprehensive complexity of diction making up the first summary;
shortening or lengthening a length of the first summary;
decreasing or increasing a playback speed of the summary audio file;
changing a language of the first summary or a playback language of the summary audio file; or
redacting or omitting one or more portions of the first summary or the summary audio file.

21-40. (canceled)
